(19) United States
(12) Patent Application Publication
(10) Pub. No.: US 2025/0085494 A1
(43) Pub. Date: Mar. 13, 2025

(54) METHOD AND APPARATUS FOR HANDLING AN OPTICAL DEVICE, METHOD FOR HANDLING A WAVEGUIDE

(71) Applicant: Applied Materials, Inc., Santa Clara, CA (US)

(72) Inventor: Davide COLLA, Treviso (IT)

(21) Appl. No.: 18/815,156

(22) Filed: Aug. 26, 2024

Related U.S. Application Data
(60) Provisional application No. 63/537,217, filed on Sep. 8, 2023.

(51) Int. Cl. G02B 6/42; G02B 6/24; G02B 6/34

(52) U.S. Cl. CPC G02B 6/4259; G02B 6/241; G02B 6/34; G02B 6/4239

(57) ABSTRACT

A method for handling an optical device is provided. The method includes providing the optical device in a suspended state using a contactless suspension system, the optical device having two major surfaces. The method includes gripping the optical device in the suspended state using a gripper having a set of side supports, wherein the gripping of the optical device includes moving the set of side supports from an open position to a closed position, wherein, in the closed position, one or more side surfaces of the optical device extending between the two major surfaces of the optical device are held by the set of side supports. The method includes transporting the optical device using the gripper.

### CROSS-REFERENCE TO RELATED APPLICATIONS

This application claims the benefit of U.S. Provisional Patent Application Ser. No. 63/537,217, filed Sep. 8, 2023, which is incorporated by reference herein in its entirety.

### FIELD

Embodiments described herein relate to apparatuses and methods for handling optical devices, specifically optical devices for augmented reality applications, such as waveguide combiners. Embodiments described herein specifically relate to apparatuses and methods for picking up, transporting and positioning optical devices using a gripper.

### BACKGROUND

Virtual reality is generally considered to be a computer-generated simulated environment in which a user has an apparent physical presence. A virtual reality experience can be generated in 3D and viewed with a head-mounted display (HMD) such as glasses or other wearable display devices that have near-eye display panels as lenses for displaying a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, augmented reality is accompanied by many challenges and design constraints.

In order to allow for a computer-generated virtual image to be combined with a real-world image of the environment so as to provide an augmented reality experience, optical combiners may be used. Such optical combiners may involve waveguides that include a substrate having a plurality of optical structures formed thereon. Since the optical structures are small (e.g. nano-sized), fragile structures that are easily damaged or contaminated, the handling of waveguides may be challenging. For example, a fast, automated processing of waveguides can be difficult, thus affecting the overall rate of productivity in the manufacture of display devices for augmented reality applications.

In light of the above, there is a need for improved systems and methods for handling optical devices such as waveguides for augmented reality applications.

### SUMMARY

According to an embodiment, a method for handling an optical device is provided. The method includes providing the optical device in a suspended state using a contactless suspension system. The optical device has two major surfaces. The method includes gripping the optical device in the suspended state using a gripper having a set of side supports. The gripping of the optical device includes moving the set of side supports from an open position to a closed position. In the closed position, one or more side surfaces of the optical device extending between the two major surfaces of the optical device are held by the set of side supports. The method includes transporting the optical device using the gripper.

According to a further embodiment, a method for handling an optical device is provided. The method includes holding the optical device in a supported state. In the supported state, the optical device is mechanically held by a holder. The optical device has two major surfaces. The method includes positioning a gripper adjacent to the optical device in the supported state. The gripper includes a set of side supports defining an optical device containment region of the gripper. The method includes, after the positioning, transferring the waveguide from the supported state to a suspended state. The transferring includes disengaging the optical device from the holder and providing the optical device in the suspended state using a contactless suspension system. The method includes providing the optical device in the suspended state in the optical device containment region of the gripper while the set of side supports is in an open position. The method includes gripping the optical device in the suspended state by moving the set of side supports from the open position to a closed position to reduce a dimension of the optical device containment region. In the closed position, one or more side surfaces of the optical device extending between the two major surfaces are held by the set of side supports. The method includes transporting the optical device away from the contactless suspension system using the gripper.

According to a further embodiment, a method for handling a waveguide is provided. The method includes holding a waveguide in a supported state. In the supported state, the waveguide is mechanically held by a holder, the waveguide having two major surfaces. The method includes transferring the waveguide from the supported state to a suspended state. The waveguide is provided in the suspended state by a contactless suspension system including an ultrasonic vibration generator. The method includes gripping the waveguide in the suspended state using a gripper. The method includes transporting the waveguide held by the gripper away from the contactless suspension system.

According to a further embodiment, an apparatus for handling an optical device is provided. The apparatus includes a contactless suspension system. The apparatus includes a gripper having a set of side supports that is movable between an open position and a closed position. The apparatus includes a controller. The controller is configured to control the contactless suspension system to provide the optical device in a suspended state. The controller is configured to control the gripper to grip the optical device in the suspended state. The gripping of the optical device includes moving the set of side supports from the open position to the closed position, wherein, in the closed position, one or more side surfaces of the optical device extending between two major surfaces of the optical device are held by the set of side supports. The controller is configured to control the gripper to transport the optical device.

Embodiments are also directed to apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed to methods for operating the described apparatus. The methods for operating the described apparatus include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIGS. 1(a)-(b) show an example of a waveguide;

FIG. 2 shows a waveguide stack including several waveguides;

FIGS. 3a-c illustrate a method for handling an optical device according to embodiments described herein;

FIGS. 4a-b show examples of a set of side supports of a gripper defining an optical device containment region as described herein;

FIGS. 5a-e illustrate a method for handling an optical device according to embodiments described herein, wherein the optical device is picked up from a support; and

FIG. 6 shows an example of a gripper as described herein, wherein the gripper is part of a rotary support.

### DETAILED DESCRIPTION

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

Embodiments described herein involve optical devices. A device may be considered an optical device if the optical properties of the device are relevant for the method or apparatus in which the device is used. At least a portion of an optical device can be made of a transparent material, such as glass or plastic. Some optical devices may be configured to change the properties, e.g. the propagation direction, of light. For example, an optical device may include optical structures for changing the propagation direction of light. Other optical devices may be unstructured and allow light to pass therethrough substantially unaltered. An optical device as described herein may be an optical device for use in augmented reality applications. An optical device can also be called an optical element. Examples of optical devices include waveguides and transparent cover elements, such as cover glasses, as described herein.

An optical device as described herein, such as a waveguide or a transparent cover element, can be a thin piece of material. An optical device can be a plate element, including a plate element having a flat surface or a plate element having a curved surface. An optical device can have a first major surface and a second major surface opposite the first major surface. An optical device may be a substantially two-dimensional device, wherein a thickness of the optical device between the first major surface and the second major surface can be much smaller (e.g. 1% or less) than a dimension, such as a length or width, of the first or second major surface. For example, the thickness of an optical device may be 1 mm or less, 500 μm or less, or 300 μm or less.

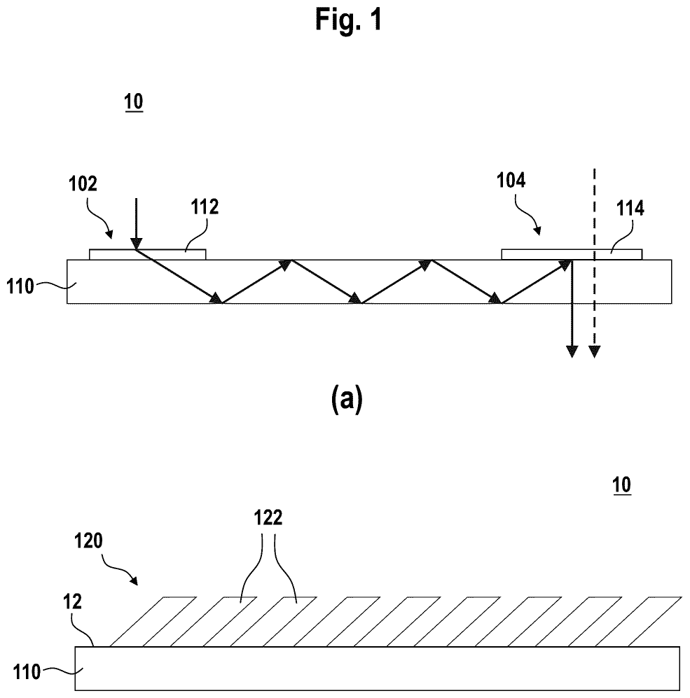

FIGS. 1(a)-(b) show an exemplary waveguide 10. As shown in FIG. 1(a), the waveguide 10 may include a substrate 110, which may be a thin piece of transparent material, such as glass or plastic. At least one grating structure, such as a grating structure 112 and a grating structure 114, may be disposed on the substrate 110. The waveguide 10 may include an input coupling region 102 defined by the grating structure 112. The waveguide 10 may include an output coupling region 104 defined by the grating structure 114. Light, in particular light corresponding to a virtual, computer-generated image, may be coupled into the waveguide 10 at the input coupling region 102. The light may propagate through the waveguide 10 until the light reaches the output coupling region 104. At the output coupling region 104, the light may exit the waveguide 10. Further, also at the output coupling region 104, light from the external, real-world surroundings may be transmitted through the waveguide 10 (as shown by the dashed line), allowing the user to see a combination of a virtual image and a real-world image. The waveguide 10 may be a waveguide combiner for providing an augmented reality experience to a user.

FIG. 1(b) shows a grating structure 120 of a waveguide 10 in more detail. The grating structure 120 may be the grating structure 112 or the grating structure 114 shown in FIG. 1(a), and may accordingly serve to provide an input coupling region or an output coupling region of the waveguide 10. The grating structure 120 may be formed on a major surface 12 of the substrate 110. The grating structure 120 may include a plurality of optical structures 122. The optical structures 122 may be configured to change a propagation direction of light incident on the grating structure 120. The optical structures 122 may have dimensions, e.g. width and/or height, that lie in the sub-micron and even nanometer range. The optical structures may be arranged adjacent to each other with a gap in between. As shown in FIG. 1(b), the optical structures 122 may be shaped, for example, as slanted fins.

The disclosure is not limited to the exemplary waveguide 10 shown in FIGS. 1(a)-(b) and applies likewise to other waveguides. For example, a waveguide may have more than two grating structures (e.g. the waveguide may have one or more intermediate regions defined by further grating structures), the arrangement and shape of the optical structures 122 may be different from the example shown in FIG. 1(b), the waveguide may have grating structures disposed on both sides of the waveguide, and so on.

A waveguide as described herein may include a substrate. A waveguide may include a plurality of optical structures formed on the substrate. The optical structures may have sub-micro-dimensions, e.g. nano-sized dimensions. The plurality of optical structures may form one or more grating structures on the substrate. A waveguide can be a waveguide combiner. A waveguide combiner may be configured for combining a virtual computer-generated image with a real-world image of a surrounding environment. A waveguide may be an augmented reality waveguide combiner.

In an optical system, such as an augmented reality device, several waveguides may be stacked on top of each other to form a waveguide stack. For example, each waveguide in the waveguide stack may be configured for manipulating light in a respective wavelength range, which is beneficial for providing color images.

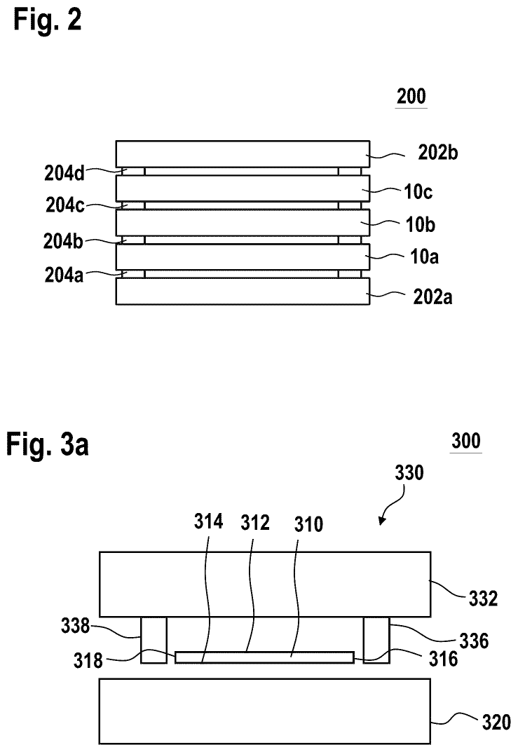

FIG. 2 shows an example of a waveguide stack 200. The waveguide stack 200 may include a cover glass 202a (bottom cover glass), a waveguide 10a, a waveguide 10b, a waveguide 10c and a cover glass 202b (top cover glass) stacked in this order. An adhesive 204a may be disposed between the cover glass 202a and the waveguide 10a. Adhesives 204b, 204c and 204d may be disposed between waveguides 10a and 10b, between waveguides 10b and 10c, and between waveguide 10c and cover glass 202b, respectively. Each of the waveguides 10a-c may be a waveguide as described herein, such as a waveguide 10 shown in FIGS. 1(a)-(b).

A cover glass, such as cover glasses 202a-b, may a protective glass. A cover glass may shield a surface of a waveguide adjacent to the cover glass, for example to prevent a grating formed on said surface from being contacted or contaminated. It may be the case that a cover glass has no optical structures, such as a grating.

An adhesive, such as adhesives 204a-d, may be configured to attach adjacent optical devices of a waveguide stack to each other. For example, adhesive 204a may be configured to attach cover glass 202a to waveguide 10a. An adhesive may be a pressure sensitive adhesive (PSA). An adhesive may be a pre-formed adhesive, such as a pre-formed PSA. An adhesive may have an elongated shape. For example, an adhesive may be an adhesive tape. An adhesive may function as a spacer providing a gap, particularly an air gap, between adjacent optical devices of the waveguide stack. Due to the adhesive, it may be the case that said adjacent optical devices do not contact each other.

The waveguide stack 200 shown in FIG. 2 includes a total of three waveguides. The disclosure is not limited thereto. A waveguide stack may include 1 or more, 2 or more, or 3 or more waveguides. For example, a waveguide stack may include a total of 2 waveguides stacked between a cover glass 202a and a cover glass 202b. In another example, a waveguide stack may include a single waveguide and a single cover glass.

Further, instead of cover glasses, transparent cover elements made of materials other than glass may be used in a waveguide stack. Throughout the present disclosure, a cover glass may be replaced by a transparent cover element.

A waveguide stack may be formed. Forming the waveguide stack may include placing a cover glass 202a on a support, placing an adhesive 204a on the cover glass 202a, placing a waveguide 10a on the adhesive 204a, placing an adhesive 204b on the waveguide 10a, and so on, in this order.

According to embodiments described herein, an optical device, such as a waveguide, is handled, e.g. picked up, moved, transported, positioned, and the like, without contacting the two major surfaces of the optical device. It may be the case that no optical structures on the major surfaces, such as grating structures of a waveguide, are touched during handling, ensuring that the optical structures are not damaged or contaminated. The optical device may be handled by side contact only, i.e., by contacting only one or more side surfaces of the optical device.

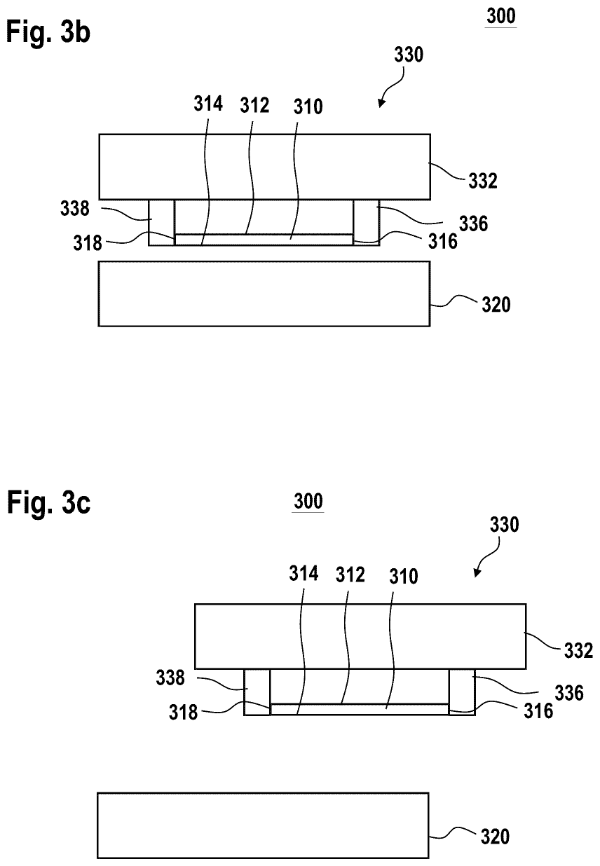

FIGS. 3a-c illustrate a method for handling an optical device 310 according to embodiments described herein. The method may be performed using an apparatus 300 for handling the optical device 310 according to embodiments described herein. The apparatus 300 may be part of a system for processing waveguides, in particular a system for manufacturing waveguide stacks.

According to an embodiment, a method for handling an optical device 310 is provided. The method includes providing the optical device 310 in a suspended state using a contactless suspension system 320. The optical device 310 has two major surfaces, such as a first major surface 312 and a second major surface 314. The method includes gripping the optical device 310 in the suspended state using a gripper 330 having a set of side supports, which may include a first side support 336 and a second side support 338. The gripping of the optical device 310 includes moving the set of side supports from an open position to a closed position. In the closed position, one or more side surfaces of the optical device extending between the two major surfaces of the optical device 310 are held by the set of side supports. The method includes transporting the optical device 310 using the gripper 330.

The optical device 310 may be a waveguide, a transparent cover element such as a cover glass, or another optical device. According to embodiments, the optical device 310 may be a waveguide including a substrate and a plurality of optical structures formed thereon. The plurality of optical structures may form a grating.

The optical device 310 may include a first major surface 312 and a second major surface 314 opposite the first major surface 312. The total area of the optical device 310 may be defined by the area of the first major surface 312 or the area of the second major surface 314. The first major surface 312 and the second major surface 314 may have substantially the same area.

The optical device 310 may have one or more side surfaces, also called edge surfaces, between the first major surface 312 and the second major surface 314. A side surface of the optical device 310 may be a thin surface extending between the first major surface 312 and the second major surface 314. A side surface may have an area which is, for example, 10% or less of the area of the first major surface 312 or the area of the second major surface 314.

The optical device 310 may include one or more side portions, such as a first side portion 316 and a second side portion 318. A side portion of the optical device 310 can be understood as a portion of a side surface of the optical device 310. A side portion extends between the first major surface 312 and the second major surface 314. A side portion is not part of a major surface of the optical device 310. A side portion may have a dimension, e.g. a length or width, corresponding to a thickness of the optical device 310 between the first major surface 312 and the second major surface 314. Where the optical device 310 is a waveguide, the first side portion 316 and the second side portion 318 of the optical device 310 may be first and second side portions, respectively, of a substrate of the waveguide.

The first side portion 316 and the second side portion 318 can be part of two different side surfaces of the optical device 310 or can be part of a same surface of the optical device 310.

In some embodiments, as illustrated in FIGS. 3a-c, the first side portion 316 and the second side portion 318 may be disposed on opposite sides of the optical device 310.

The apparatus 300 includes a contactless suspension system 320. The contactless suspension system 320, also called contactless levitation system, is configured for contactlessly suspending the optical device 310. The term “contactlessly suspending” can be understood in the sense that the optical device 310 is provided in a suspended state, or floating state, wherein the contactless suspension system 320 does not include a mechanical support carrying the weight of the optical device 310 by means of contact between the mechanical support and the optical device 310. While the optical device 310 is contactlessly suspended by the contactless suspension system 320, it may be the case that there is no contact between the optical device 310 and the contactless suspension system 320. The contactless suspension system 320 may exert a contactless action on the optical device 310 that holds the optical device 310 at a predetermined distance from the contactless suspension system 320. The predetermined distance may be adjustable by controlling a magnitude of a contactless force exerted by the contactless suspension system 320 on the optical device 310. A contactless suspension system 320 may, for example, include an ultrasonic vibration generator, as described below.

The fact that the optical device 310 is contactlessly acted upon by the contactless suspension system 320 does not exclude portions of the optical device 310 from being contacted by other parts of the apparatus 300. For example, as will be described below, while the optical device 310 is provided in a suspended state by the contactless suspension system 320, one or more side supports of a gripper may contact side portions of the optical device 310. Still, according to embodiments described herein, the apparatus 300 is configured for handling the optical device 310 by side contact only, that is to say, by contacting only one or more side surfaces of the optical device 310. According to embodiments, the apparatus 300 may be configured to handle the optical device 310 without contacting the two major surfaces of the optical device 310.

The apparatus 300 includes a gripper 330. For example, the gripper 330 may be part of a positioning device, such as a pick-and-place device, which may be configured for picking up, transporting, positioning and/or aligning, and the like, of the optical device 310. In another example, the gripper 330 may be an end effector connected to a support, for example a rotary support, such as a rotary table, which may be configured to move the optical device to one or more processing positions by rotation of the support.

The gripper 330 may be configured to grip an optical device and transport the optical device away from the contactless suspension system 320. It may be the case that the contactless suspension system 320 is a stationary system that is not part of the gripper 330.

The gripper may include a gripper body 332, which may be a gripper head. The gripper body 332 may be connected to an actuator for moving the gripper, e.g. to allow for transportation of an optical device held by the gripper 330.

The gripper 330 includes a set of side supports. Each side support of the set of side supports may be connected to the gripper body 332. As illustrated in FIGS. 3a-c, the set of side supports may include a first side support 336 and a second side support 338. The disclosure is not limited thereto, and the set of side supports may include any number of side supports. A side support of the set of side supports of the gripper 330, such as the first side support 336, the second side support 338 or any other side support, may be configured for contacting a side surface of the optical device 310. It may be the case that a side support does not contact the two major surfaces of the optical device while the optical device 310 is handled by the gripper 330.

According to embodiments, the set of side supports may define an optical device containment region of the gripper. The optical device containment region may be an area inside which the optical device can be received by the gripper. The optical device containment region may be disposed at least partially between the side supports. For example, as illustrated in FIG. 3a, the optical device 310 may be received in an optical device containment region between the first side support 336 and the second side support 338. The first side support 336 and the second side support 338 may be disposed on opposite sides of the optical device containment region.

The set of side supports is movable between an open position and a closed position. FIG. 3a shows the set of side supports in an open position. According to embodiments, in the open position, a dimension of the optical device containment region may be larger than a corresponding dimension of the optical device to allow for a tolerance between the optical device and the set of side supports. In the open position, the space between the side supports may be sufficiently large to allow the optical device to enter into the optical device containment region.

As shown in FIG. 3a, while the optical device 310 is in a suspended state, the gripper 330 may be disposed over the optical device 310 in a manner such that the optical device 310 is within the optical device containment region while the set of side supports is in the open position. In the configuration shown in FIG. 3a, the optical device 310, which is in a suspended state, is prevented from floating sideward due to arrangement of the side supports. The optical device 310 in the suspended state is contained within the optical device containment region.

As shown in FIG. 3b, the optical device 310 in the suspended state may be gripped by the gripper 330. While the optical device 310 is in the suspended state, the set of side supports, e.g. the first side support 336 and the second side support 338, may move from the open position to a closed position. One or more side supports of the set of side supports may be movable side supports. The one or more movable side supports may be movable to change the set of side supports between the open position and the closed position. The one or more movable side supports may be movable with respect to one or more other side supports of the set of side supports and/or with respect to the gripper body 332. The one or more movable side supports may be connected to an actuator for moving the set of side supports between the open position and the closed position. In the example shown in FIGS. 3a-c, the first side support 336 or the second side support 338, or both side supports, may be movable to change the set of side supports between the open position and the closed position.

According to embodiments, a dimension, such as a length, width or other dimension, of the optical device containment region may be adjustable by adjusting a position of one or more movable side supports of the set of side supports. Particularly, moving the set of side supports from the open position to the closed position may reduce the dimension of the optical device containment region.

FIG. 3b shows the set of side supports in the closed position gripping the optical device 310 by side contact. The set of side supports may be moved from the open position to the closed position until the optical device 310 is no longer in a state of contactless suspension. In the closed position of the set of side supports, the optical device 310 may be mechanically gripped by the set of side supports by side contact. In the closed position, one or more side surfaces of the optical device 310 may be held, particularly clamped, between the set of side supports. In the closed position, a first side portion 316 of the optical device 310 may be pressed against a first side support 336 of the set of side supports and a second side portion 318 of the optical device 310 may be pressed against a second side support 338 of the set of side supports. The first side portion 316 and the second side portion 318 may be held, particularly clamped, between the first side support 336 and the second side support 338.

Embodiments described herein provide the advantage that the optical device is in a suspended state at the time when the set of side supports moves from the open position to the closed position to grip the optical device 310. During the movement to close the set of side supports, the optical device, being in a suspended state, is allowed to float freely in the space between the side supports, in other words in the optical device containment region, until the closed position is reached and the optical device 310 is firmly gripped by the set of side supports. In light thereof, the gripping process can be carefully performed with a high degree of control that allows avoiding contamination, deformations or damage to the optical device 310. In comparison, if the optical device 310 would rest on a mechanical support, i.e. a non-contactless support, while the set of side supports moves from the open to the closed position to grip the optical device 310, then the contact between the optical device and the support involves a risk that the moving side supports would displace the optical device, possibly leading to scratches or other contamination, and/or would apply unevenly balanced forces to the optical device that could strain or deform the optical device. Such risks are avoided by gripping the optical device while the optical device is in free-floating state, according to embodiments described herein.

After the set of side supports has been brought into the closed position to grip the optical device, the weight of the optical device 310 may be carried by the gripper 330. The optical device 310 has been transferred from the contactless suspension system 320 to the gripper 330. The contactless suspension system 320 may be switched off. According to embodiments, the gripper 330 may transport the optical device 310 away from the contactless suspension system 320, as illustrated in FIG. 3c. According to embodiments, the optical device 310 is transported by the gripper 330 without contacting the two major surfaces of the optical device 310.

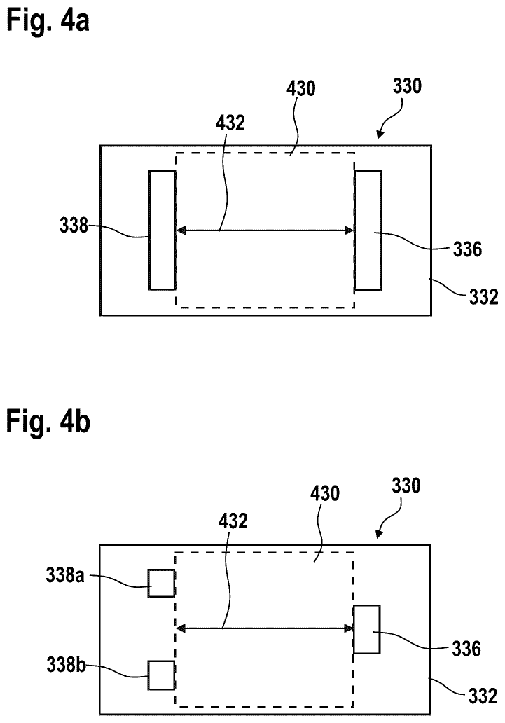

FIGS. 4a-b show examples of a gripper 330 in a bottom view. FIG. 4a shows a set of side supports consisting of a first side support 336 and a second side support 338 defining an optical device containment region 430. The first side support 336 and the second side support 338 may be disposed on opposite sides of the optical device containment region 430. A position of the first side support 336 and/or of the second side support 338 may be adjustable to adjust a dimension 432 of the optical device containment region 430. When the set of side supports is moved from the open position to the closed position, the dimension 432 may decrease. When the set of side supports is moved from the closed position to the open position, the dimension 432 may increase. FIG. 4b shows another example of a gripper 330, having a set of side supports consisting of a first side support 336, a second side support 338a and another second side support 338b defining a corresponding optical device containment region 430. For example, a position of the first side support 336 may be adjustable to adjust a dimension 432 of the optical device containment region 430, while the second side supports 338a-b may be fixed side supports. The exemplary arrangements of side supports as shown in FIGS. 4a-b are for the purpose of illustration and it shall be understood that, in a similar manner, a plurality of other configurations for the set of side supports can be provided.

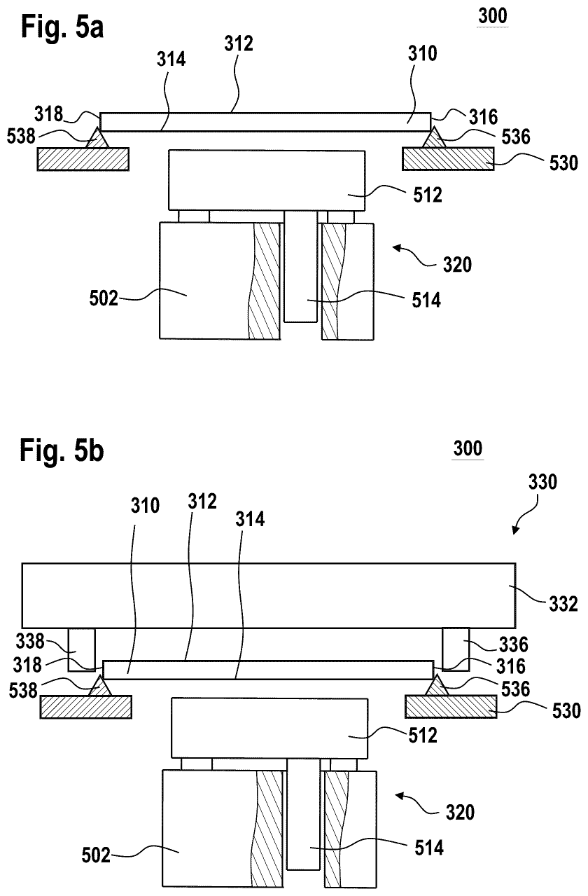

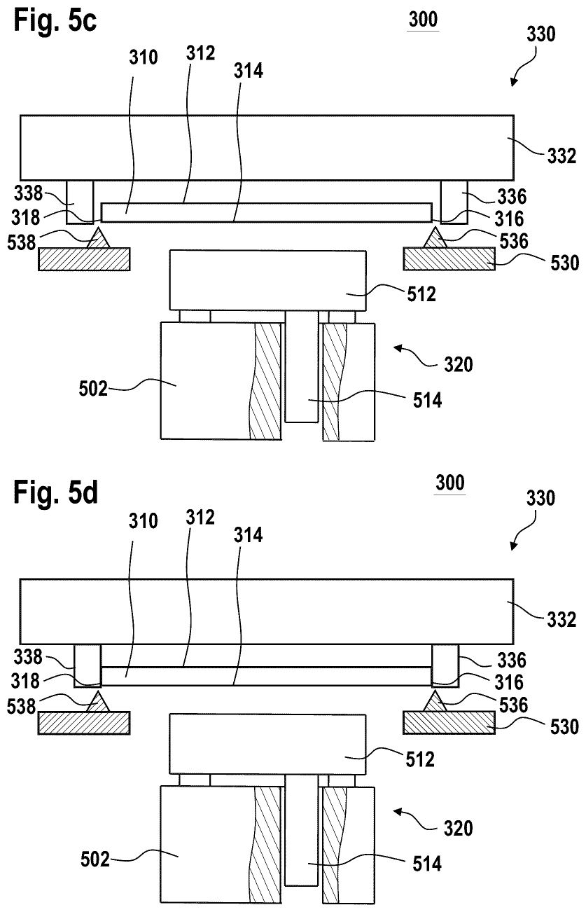

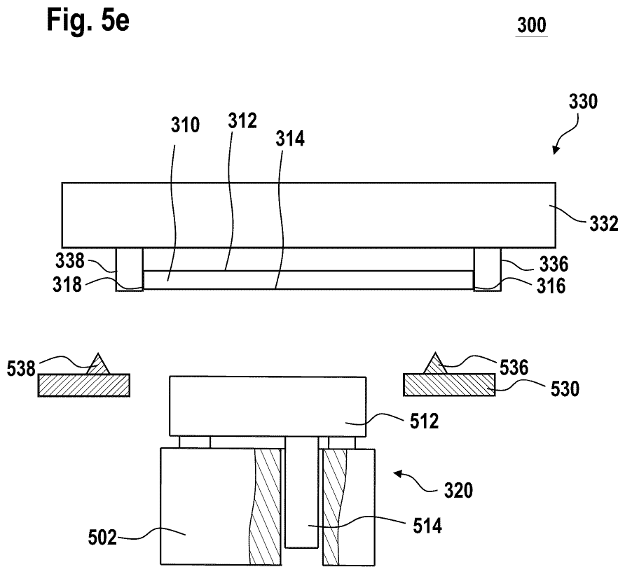

The method for handling an optical device 310 according to embodiments described herein may be a method for transferring the optical device 310 from a support 530 to the gripper 330 via a contactless suspended state provided by the contactless suspension system 320, as illustrated for example in FIGS. 5a-e.

FIG. 5a illustrates a first phase. The optical device 310 may be supported by a support 530. For example, the optical device 310 may be supported by a set of support portions, which may include a first support portion 536 and/or a second support portion 538, and/or potentially other support portions, of the support 530. The support 530 may be a mechanical support for supporting the optical device by contact. The support 530 may support the optical device 310 without contacting the major surfaces of the optical device 310.

The contactless suspension system 320 may be disposed adjacent to, e.g. facing, the optical device 310 that is supported by the support 530. For example, but without limitation, the contactless suspension system 320 may be disposed below the optical device 310 supported by the support 530. As illustrated in FIG. 5a, the optical device 310 may be supported by the support 530 while the contactless suspension system 320 is inactive.

Not limited to the apparatus 300 shown in FIGS. 5a-e and applicable to any embodiment described herein, the contactless suspension system 320 may include an ultrasonic vibration generator. The ultrasonic vibration generator may be configured to provide ultrasonic vibrations. The ultrasonic vibration generator may provide a contactless repulsive force acting on the optical device 310.

The ultrasonic vibration generator may include a sonotrode 514. The sonotrode 514 may be mounted to a body portion 502 of the contactless suspension system 320. The sonotrode 514 may be configured for providing ultrasonic vibrations. The ultrasonic vibrations may result in a repulsive contactless force pushing the optical device 310 away from the contactless suspension system 320, e.g. upward. The ultrasonic vibration generator may include a resonating element 512, such as a resonating plate (also called vibrating plate), that may be connected to the sonotrode 514. The resonating element 512 may have one or more flat portions arranged for facing the optical device 310. The resonating element 512 may be configured for transmitting the ultrasonic vibrations created by the sonotrode 514 to an optical device receiving area of the contactless suspension system 320.

As illustrated, the contactless suspension system 320 may act on the optical device 310 from below the optical device 310. The sonotrode 514 and/or the resonating element 512 may be disposed below an optical device receiving area of the contactless suspension system 320. The repulsive force provided by the ultrasonic vibration generator may be an upward force.

By the combination of the repulsive upward contactless force provided by the ultrasonic vibration generator and the downward action of gravity on the optical device 310 (i.e. the weight of the optical device 310), a contactless suspension of the optical device 310 can be provided. Due to the upward repulsive contactless force provided by the ultrasonic vibration generator, an air cushion is created, preventing the optical device, that is forced downwards by the action of gravity, from contacting the resonating element 512. The optical device 310 may be maintained in a floating state without there being contact between the optical device 310 and the contactless suspension system. The vertical position of the suspended optical device can be adjusted by controlling the magnitude of the repulsive contactless force exerted by the ultrasonic vibration generator, particularly by controlling the magnitude of the ultrasonic vibrations generated by the sonotrode 514.

The contactless suspension system 320 is not limited to a contactless suspension system that acts on the optical device 310 from below as illustrated in the figures. In other embodiments, the contactless suspension system 320 may be arranged above the optical device 310. In such a case, the repulsive contactless force provided by the ultrasonic vibration generator may be a downward force. The contactless suspension system 320 may include a suction circuit, such as a vacuum circuit, to apply a contactless lifting force to the optical device 310. By a combination of the contactless lifting force provided by the suction circuit and the downward contactless force provided by the ultrasonic vibration generator to provide an air cushion, the optical device 310 can be provided in a contactlessly suspended state by a contactless suspension system 320 acting on the optical device 310 from above.

According to embodiments, the contactless suspension system may include an ultrasonic vibration generator for providing a contactless repulsive force acting on the optical device.

FIG. 5b illustrates a second phase, which may take place after the first phase. The gripper 330 may be positioned adjacent to the optical device 310 that is supported by the support 530. As illustrated in FIG. 5b, the gripper 330 may be positioned adjacent to the optical device 310 supported by the support 530 in a manner such that the optical device 310 faces and/or is at least partially inside the optical device containment region defined by the set of side supports of the gripper while the set of side supports is in the open position. The contactless suspension system 320 may be inactive, so that the optical device 310 is supported by the support 530 and is not in a state of contactless suspension.

FIG. 5c illustrates a third phase, which may take place after the second phase. The gripper 330 in FIG. 5c may be in substantially the same position as in FIG. 5b. The contactless suspension system 320 may act contactlessly on the optical device 310 to disengage the optical device 310 from the support 530, particularly to lift the optical device 310 from the support 530. For example, ultrasonic vibrations may be provided by controlling the ultrasonic vibration generator to lift the optical device 310 off the support 530. The optical device 310 may be in a suspended state directly after the optical device 310 is disengaged from the support 530. As the optical device 310 is disengaged, particularly lifted, from the support 530 and provided in a suspended state by the contactless suspension system 320, a sideward movement of the optical device 310 may be prevented by the set of side supports of the gripper 330, which may be in the open position. The optical device 310 in the suspended state may be provided in the optical device containment region of the gripper 330 while the set of side supports in the open position prevents a sideward movement of the optical device 310. FIG. 5c shows the optical device 310 in the optical device containment region. While the optical device is in the suspended state and while the set of side supports is in the open position, it may be the case that the optical device is neither supported by the support 530 nor held by the gripper 330. The optical device 310 in the suspended state may be permitted to float freely within the optical device containment region defined by the set of side supports in the open position.

According to embodiments, the optical device may be held in a supported state. In the supported state, the optical device is mechanically held by a holder. A holder can, for example, be a support, such as the support 530. Yet the disclosure is not limited thereto, and the holder can be a different kind of holder. For example, the holder can be another gripper, such as the gripper 630 described herein. That the optical device is mechanically held by the holder can be understood in the sense that the optical device is held by contact between the optical device and the holder. The weight of the optical device may be carried mechanically by the holder. A mechanical holding of the optical device is distinguished from a contactless suspension of the optical device. For example, the optical device can be mechanically held by the support 530, wherein the optical device rests on the first support portion 536 and the second support portion 538. In another example, the optical device can be mechanically held by a gripper, such as gripper 630 described below.

The gripper, such as the gripper 330, may be positioned adjacent to the optical device in the supported state. After the positioning of the gripper, the optical device may be transferred from the supported state to a suspended state. The transferring may include disengaging the optical device from the holder. The transferring may include providing the optical device in the suspended state. The optical device may be in the suspended state directly after disengaging the optical device from the holder. In some embodiments, such as embodiments where the holder is a support 530, disengaging the optical device from the holder may include lifting the optical device from the holder by a contactless suspension force provided by the contactless suspension system to provide the optical device in the suspended state. Upon disengaging the optical device from the holder, a sideward movement of the optical device may be restricted by the set of side supports of the gripper.

FIG. 5d illustrates a fourth phase, which may take place after the third phase. The gripper 330 in FIG. 5d may be in substantially the same position as in FIG. 5c. The optical device 310 provided in the suspended state in the optical device containment region (e.g. by controlling the ultrasonic vibration generator) may be gripped, particularly clamped, by moving the set of side supports from the open position to the closed position. The operations in question are similar to those described with respect to FIG. 3b and will not be repeated here. The advantages are the same, namely that the optical device 310 is gripped while being in a floating state wherein the sideward movement of the optical device 310 is contained within the optical device containment region, so that the gripping process can be performed in highly controlled manner without damaging the optical device 310.

In light of the above, the optical device 310 may be transferred from the support 530 to the gripper 330 via a contactlessly suspended state provided by the contactless suspension system 320.

After the optical device 310 has been gripped by the set of side supports of the gripper 330, the contactless force provided by the contactless suspension system may be switched off.

FIG. 5e illustrates a fifth phase, which may take place after the fourth phase. The gripper 330 holding the optical device 310 may transport the optical device 310 away from the support 530 and/or away from the contactless suspension system 320.

The sequence of operations described with respect to FIGS. 5a-e, and likewise the sequence of operations described with respect to FIGS. 3a-c, can be inverted for releasing the optical device 310 from the gripper 330. A method for transferring the optical device 310 from the gripper 330 to a contactless suspension system may be provided. The contactless suspension system may be the contactless suspension system 320, i.e. the same contactless suspension system from which the optical device 310 was initially picked up, or another contactless suspension system (which may have a similar design, e.g. including an ultrasonic vibration generator). The gripper 330 may initially hold the optical device 310 by the set of side supports which are in the closed position. The gripper 330 holding the optical device 310 may move to a position adjacent to, e.g. facing, the contactless suspension system. The contactless suspension system may provide a contactless suspension force. The optical device 310 held by the set of side supports in the closed position may be in a position within reach of said contactless suspension force. While the contactless suspension force is provided, the set of side supports may be moved from the closed position to the open position to release the optical device 310 from the gripper 330. Upon providing the set of side supports in the open position, the optical device 310 is provided in a suspended state by the contactless suspension force provided by contactless suspension system. In some embodiments, for example if a support 530 is present, or another support adjacent to the contactless suspension system, the contactless suspension force provided by the contactless suspension system may be controlled to lower the optical device 310 onto the support. After the optical device 310 has been placed on the support, the contactless suspension force may be switched off. A method for transferring the optical device 310 from the gripper 330 to a support via a suspended state provided by a contactless suspension system is provided.

According to embodiments, the contactless suspension system may be a first contactless suspension system. The optical device held by the gripper may be positioned adjacent to a second contactless suspension system. The second contactless suspension system may be equal to or different from the first contactless suspension system. A contactless suspension force may be provided by the second contactless suspension system. The optical device may be released from the gripper while the contactless suspension force acts on the optical device to provide the optical device in a suspended state using the second contactless suspension system.

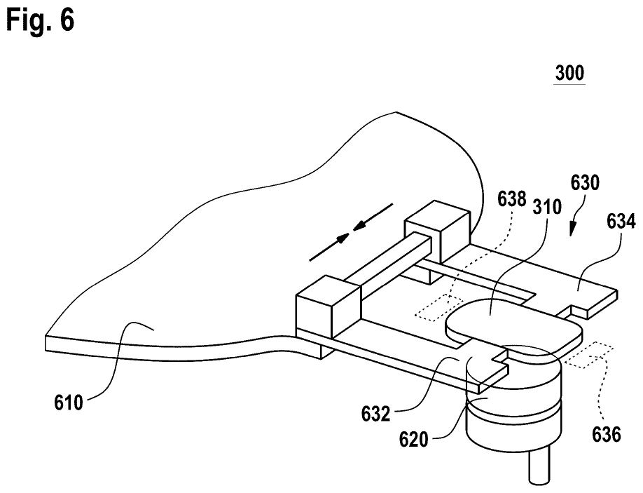

FIG. 6 shows an apparatus 300 for handling an optical device 310 according to embodiments described herein.

The apparatus 300 may include a contactless suspension system 620. The contactless suspension system 620, also called contactless levitation system, may be configured for contactlessly suspending an optical device 310. The contactless suspension system 620 may be similar to the contactless suspension system 320. Any of the aspects described herein with respect to the contactless suspension system 320 may also be applied to the contactless suspension system 620. For example, the contactless suspension system 620 may include an ultrasonic vibration generator as described herein.

The apparatus 300 may include a gripper 630. As shown in FIG. 6, the gripper 630 may be connected to a support 610, which may be a rotary support, e.g. a rotary table, of the apparatus 300. The support 610 may be movable over an angle, e.g. to perform a rotation with respect to a vertical rotation axis. The support 610 may be configured to move the optical device 310 held by the gripper 630 to one or more processing positions by rotation of the support 610.

The gripper 630 may be configured to grip an optical device and transport the optical device away from the contactless suspension system 620. It may be the case that the contactless suspension system 620 is a stationary system that is not part of the gripper 630.

The gripper 630 may include a set of side supports. As illustrated in FIG. 6, the set of side supports may include a first side support 632 and a second side support 634. The disclosure is not limited thereto, and the set of side supports may include any number of side supports. A side support of the set of side supports of the gripper 630, such as the first side support 632, the second side support 634 or any other side support, may be configured for contacting a side surface of the optical device 310. It may be the case that a side support does not contact the two major surfaces of the optical device while the optical device 310 is handled by the gripper 630.

The set of side supports of the gripper 630 may define an optical device containment region of the gripper 630. The optical device containment region may have any of the features or aspects of the optical device containment region of the gripper 330 described herein, and the discussion will not be repeated.

The set of side supports of the gripper 630 may be movable between an open position and a closed position. FIG. 6 shows the set of side supports in a closed position. The notions of the open position and the closed position of the set of side supports of the gripper 630 are analogous to the same notions described with respect to the gripper 330 and the discussion shall not be repeated here.

The gripper 630 may perform the same functions as the gripper 330 described above.

In one example, the gripper 630 may be used to grip the optical device 310 while the optical device is provided in a suspended state by the contactless suspension system 620, by moving the set of side supports of the gripper 630 from the open position to the closed position while the optical device is contactlessly suspended. The procedure is analogous to the procedure described with respect to FIGS. 3a-c and 5a-e for the gripper 330.

In another example, the gripper 630 holding the optical device 310 in a position adjacent to the contactless suspension system 620 (see e.g. the configuration shown in FIG. 6) may release the optical device 310 by moving the set of side supports from the closed position to the open position while the contactless suspension system 620 is active. The optical device 310 may be transferred from the gripper 630 to a suspended state provided by the contactless suspension system 620. The operations in question are analogous to a corresponding procedure as described above in relation to the gripper 330.

According to embodiments, the apparatus 300 may include the elements shown in FIG. 6 and may additionally include the gripper 330. The optical device 310 may be transferred from the gripper 630 to the gripper 330 via the contactless suspension system 620.

The optical device 310 held by the set of side supports of the gripper 630 while said set of side supports is in a closed position may be positioned adjacent to the contactless suspension system 620, for example in the configuration shown in FIG. 6. The optical device 310 held by the gripper 630 may face the contactless suspension system 620. In the configuration at hand, the gripper 630 functions as a holder that mechanically holds the optical device 310.

While the gripper 630 holding the optical device 310 is disposed adjacent to the contactless suspension system 620, the gripper 330 may be positioned adjacent to the contactless suspension system 620 in a position suitable for receiving the optical device 310. The gripper 330 may be positioned in a position facing the contactless suspension system 620. The set of side supports of the gripper 330 may be in the open position. The gripper 330 may be positioned in a manner such that the optical device 310 held by the gripper 630 faces and/or is disposed at least partially inside the optical device containment region of the gripper 330. For example, the optical device 310 held by the gripper 630 may be directly below or may be inside the optical device containment region of the gripper 330. For example, the gripper 330 may be positioned such that the first side support 336 and the second side support 338 are disposed in a first region 636 and a second region 638, respectively, on opposite sides of the optical device 310 held by the gripper 630, as illustrated schematically in FIG. 6.

While the gripper 630 holding the optical device 310 is disposed adjacent to the contactless suspension system 620 and while the gripper 330 is also disposed adjacent to the contactless suspension system 620, a contactless suspension force may be provided by the contactless suspension system 620. The optical device 310 that is held by the gripper 630 may be within reach of the contactless suspension force. At the present stage, the optical device 310 may still be held (mechanically held) only by the gripper 630, even though the contactless suspension system 620 has been activated.

While the gripper 630 is disposed adjacent to the contactless suspension system 620, while the gripper 330 is also disposed adjacent to the contactless suspension system 620 and while the contactless suspension force is provided, the set of side supports of the gripper 630 (e.g. the first side support 632 and the second side support 634 shown in FIG. 6) may be moved from the closed position to the open position to disengage the optical device 310 from the gripper 630. Directly upon disengaging the optical device 310 from the gripper 630, the optical device 310 may be provided in a suspended state by the contactless suspension force that was already present. While the optical device 310 is provided in the suspended state by the contactless suspension force, the optical device is neither gripped by the gripper 330 nor by the gripper 630. While the optical device 310 is provided in the suspended state, the set of side supports of the gripper 330 in the open position and/or the set of side supports of the gripper 630 in the open position may prevent a sideward movement of the optical device 310. The set of side supports of the gripper 330 and/or the set of side supports of the gripper 630 may form a cage restricting a sideward floating movement of the contactlessly suspended optical device 310. If at the present stage the optical device 310 is not yet disposed inside the optical device containment region of the gripper 330 (e.g. if the set of side supports of the gripper 330 is disposed slightly above the contactlessly suspended optical device 310), the contactless suspension force may be controlled to guide, particularly lift, the optical device 310 into the optical device containment region of the gripper 330. The aforementioned operation may not be needed, for example if the gripper 330 was already positioned in a manner such that the optical device was inside the optical device containment region thereof at the time when the optical device 310 was held by the gripper 630.

While the optical device 310 is provided in a suspended state (by the contactless suspension force) in the optical device containment region of the gripper 330, the set of side supports of the gripper 330 may be moved from the open position to the closed position to grip the optical device 310. The operation in question is similar to the procedure described above. The optical device 310 has been transferred from the gripper 630 to the gripper 330 via the contactless suspension system 620.

In a similar manner, the optical device 310 may be transferred from the gripper 330 to the gripper 630. Further, while the above example describes the gripper 630 as being connected to a rotary support, the disclosure us not limited thereto, and a transfer of an optical device between any two suitable grippers may be considered analogously.

According to embodiments, the gripper (e.g. gripper 330) may be a second gripper. The method described herein may be a method of transferring the optical device from a first gripper (e.g. gripper 630) to the second gripper via a contactless suspension system (e.g. contactless suspension system 620). The optical device may be held by the first gripper. The optical device held by the first gripper may be positioned adjacent to the contactless suspension system. A contactless suspension force may be provided by the contactless suspension system, particularly while the optical device held by the first gripper is adjacent to the contactless suspension system. The optical device may be released from the first gripper while the contactless suspension force acts on the optical device, so that the optical device is provided in a suspended state upon release from the first gripper. After releasing the optical device from the first gripper, the optical device in the suspended state may be gripped by the second gripper by moving the set of side supports from the open position to the closed position.

According to a further embodiment, a method for handling an optical device is provided. The method includes holding the optical device in a supported state. In the supported state, the optical device is mechanically held by a holder. The optical device has two major surfaces. The method includes positioning a gripper adjacent to the optical device in the supported state. The gripper includes a set of side supports defining an optical device containment region of the gripper. The method includes, after the positioning, transferring the waveguide from the supported state to a suspended state. The transferring includes disengaging the optical device from the holder and providing the optical device in the suspended state using a contactless suspension system. The method includes providing the optical device in the suspended state in the optical device containment region of the gripper while the set of side supports is in an open position. The method includes gripping the optical device in the suspended state by moving the set of side supports from the open position to a closed position to reduce a dimension of the optical device containment region. In the closed position, one or more side surfaces of the optical device extending between the two major surfaces are held by the set of side supports. The method includes transporting the optical device away from the contactless suspension system using the gripper. The method may include any aspect or combination of aspects of a method for handling an optical device according to embodiments described herein.

Positioning a gripper adjacent to the optical device in the supported state may include providing the gripper in a position wherein the gripper faces the optical device in the supported state. The adjacent position may be a position allowing the optical device to be picked up by the gripper.

According to a further embodiment, an apparatus for handling an optical device is provided. The apparatus includes a contactless suspension system. The apparatus includes a gripper having a set of side supports that is movable between an open position and a closed position. The apparatus includes a controller. The controller is configured to control the contactless suspension system to provide the optical device in a suspended state. The controller is configured to control the gripper to grip the optical device in the suspended state. The gripping of the optical device includes moving the set of side supports from the open position to the closed position, wherein, in the closed position, one or more side surfaces of the optical device extending between two major surfaces of the optical device are held by the set of side supports. The controller is configured to control the gripper to transport the optical device. The apparatus may be configured to perform any aspect or combination of aspects of a method for handling an optical device according to embodiments described herein.

The above description relates to a gripper having a set of side supports that is movable between an open position and a closed position to grip and release an optical device. The disclosure is not limited thereto and a different kind of gripper can be used to perform a method similar to the method described above. An optical device, such as a waveguide, may be mechanically supported by a holder as described herein, may be provided in a suspended state by a contactless suspension system, and the waveguide in the suspended state may be gripped by a gripper. Instead of a set of side supports as described above, the gripper may, for example, use a contactless suspension system that is built into the gripper for gripping the waveguide. For example, the contactless suspension system of the gripper may include a vacuum circuit for lifting the waveguide by suction and a sonotrode for creating an air cushion against which the waveguide is suctioned. The balance between the suctioning force and the air cushion can allow the waveguide to be held without contact by the gripper. See PCT application PCT/EP2023/052820, which is incorporated herein, for further details regarding such a gripper (e.g. gripper 300 described therein). In another example, the gripper may mechanically hold a major surface of the waveguide (e.g. the upper major surface) at one or more designated locations that will not be actually used in a subsequent optical system of which the waveguide will form part, so that a contact, and a possible contamination of said locations is irrelevant. See PCT application PCT/EP2023/052822, which is incorporated herein, for further details regarding such a gripper (e.g. gripper 800 described therein). It shall be understood that other examples of grippers can be provided. In each case, the waveguide may be transferred from a mechanically supported state to a contactlessly suspended state and, while being suspended, the waveguide may be gripped by the gripper and subsequently transported by the gripper to a target location for further processing.

According to a further embodiment, a method for handling a waveguide is provided. The method includes holding a waveguide in a supported state. In the supported state, the waveguide is mechanically held by a holder. The waveguide has two major surfaces. The method includes transferring the waveguide from the supported state to a suspended state. The waveguide is provided in the suspended state by a contactless suspension system including an ultrasonic vibration generator. The method includes gripping the waveguide in the suspended state using a gripper. The method includes transporting the waveguide held by the gripper away from the contactless suspension system.

The method may include any aspect or combination of aspects of a method for handling an optical device according to embodiments described herein, particularly wherein the optical device is taken to be a waveguide.

In the supported state, the waveguide may be mechanically held by the holder without contacting the major surfaces of the waveguide. The waveguide in the suspended state may be gripped by the gripper without contacting the major surfaces of the waveguide.

According to embodiments, the method may include positioning the gripper adjacent to the waveguide in the supported state, wherein the transferring of the waveguide from the supported state to the suspended state is performed after the positioning,

According to embodiments, the transferring of the waveguide from the supported state to the suspended state may include lifting the waveguide from the holder by a contactless suspension force provided by the contactless suspension system. The contactless suspension force may move the waveguide from the holder to a waveguide receiving area of the gripper.

According to embodiments, the contactless suspension system may be a first contactless suspension system. The method may include positioning the waveguide held by the gripper adjacent to a second contactless suspension system. The second contactless suspension system may be equal to or different from the first contactless suspension system. The method may include providing a contactless suspension force by the second contactless suspension system. The method may include releasing the waveguide from the gripper while the contactless suspension force acts on the waveguide to provide the waveguide in a suspended state using the second contactless suspension system.

The following Embodiments 1 through 17 also form part of the present disclosure:

Embodiment 1. A method for handling an optical device (10, 10a-c, 202a-b, 310), comprising:
providing the optical device in a suspended state using a contactless suspension system (320, 620), the optical device having two major surfaces (12, 312, 314);
gripping the optical device in the suspended state using a gripper (330, 630) having a set of side supports (336, 338, 338a-b; 632, 634), wherein the gripping of the optical device includes moving the set of side supports from an open position to a closed position, wherein, in the closed position, one or more side surfaces (316, 318) of the optical device extending between the two major surfaces of the optical device are held by the set of side supports; and
transporting the optical device using the gripper.

Embodiment 2. The method of Embodiment 1, wherein the optical device is a waveguide (10, 10a-c) comprising a substrate (110) and a plurality of optical structures (122) formed thereon.

Embodiment 3. The method of Embodiment 1 or 2, wherein the optical device is transported by the gripper without contacting the two major surfaces of the optical device.

Embodiment 4. The method of any of the preceding Embodiments, wherein the set of side supports defines an optical device containment region (430) of the gripper, wherein a dimension (432) of the optical device containment region is adjustable by adjusting a position of at least one side support of the set of side supports, particularly wherein moving the set of side supports from the open position to the closed position reduces the dimension of the optical device containment region.

Embodiment 5. The method of Embodiment 4, wherein, in the open position of the set of side supports, a dimension (432) of the optical device containment region is larger than a corresponding dimension of the optical device to allow for a tolerance between the optical device and the set of side supports.

Embodiment 6. The method of any of the preceding Embodiments, further comprising:
holding the optical device in a supported state, wherein in the supported state the optical device is mechanically held by a holder (530, 630);
positioning the gripper adjacent to the optical device in the supported state;
after the positioning, transferring the optical device from the supported state to the suspended state, wherein the transferring includes:
   disengaging the optical device from the holder; and
   providing the optical device in the suspended state.

Embodiment 7. The method of Embodiment 6, wherein disengaging the optical device from the holder includes lifting the optical device from the holder by a contactless suspension force provided by the contactless suspension system to provide the optical device in the suspended state.

Embodiment 8. The method of Embodiment 6 or 7, wherein, upon disengaging the optical device from the holder, a sideward movement of the optical device is restricted by the set of side supports of the gripper.

Embodiment 9. The method of any of the preceding Embodiments, wherein the contactless suspension system comprises an ultrasonic vibration generator (512, 514) for providing a contactless repulsive force acting on the optical device.

Embodiment 10. The method of any of the preceding Embodiments, wherein the contactless suspension system is a first contactless suspension system (320), the method further comprising:
positioning the optical device held by the gripper adjacent to a second contactless suspension system (620), wherein the second contactless suspension system is equal to or different from the first contactless suspension system;
providing a contactless suspension force by the second contactless suspension system; and
releasing the optical device from the gripper while the contactless suspension force acts on the optical device to provide the optical device in a suspended state using the second contactless suspension system.

Embodiment 11. The method of any of the preceding Embodiments, wherein the gripper is a second gripper (330), wherein the method is a method of transferring the optical device from a first gripper (630) to the second gripper via the contactless suspension system (620), the method further comprising:
holding the optical device using the first gripper;
positioning the optical device held by the first gripper adjacent to the contactless suspension system;
providing a contactless suspension force by the contactless suspension system; and
releasing the optical device from the first gripper while the contactless suspension force acts on the optical device, so that the optical device is provided in a suspended state upon release from the first gripper,
wherein, after the releasing, the optical device in the suspended state is gripped by the second gripper by providing of the set of side supports in the closed position.

Embodiment 12. A method for handling an optical device (10, 10a-c, 202a-b, 310), comprising:
holding the optical device in a supported state, wherein in the supported state the optical device is mechanically held by a holder (530, 630), the optical device having two major surfaces (12, 312, 314);
positioning a gripper (330, 630) adjacent to the optical device in the supported state, the gripper including a set of side supports (336, 338, 338a-b; 632, 634) defining an optical device containment region (430) of the gripper;
after the positioning, transferring the optical device from the supported state to a suspended state, wherein the transferring includes:
   disengaging the optical device from the holder; and
   providing the optical device in the suspended state using a contactless suspension system (320, 620);
providing the optical device in the suspended state in the optical device containment region of the gripper while the set of side supports is in an open position;
gripping the optical device in the suspended state by moving the set of side supports from the open position to a closed position to reduce a dimension (432) of the optical device containment region, wherein, in the closed position, one or more side surfaces of the optical device (316, 318) extending between the two major surfaces are held by the set of side supports; and
transporting the optical device away from the contactless suspension system using the gripper.

Embodiment 13. A method for handling a waveguide, comprising:
holding a waveguide (10, 10a-c, 310) in a supported state, wherein in the supported state the waveguide is mechanically held by a holder (530, 630), the waveguide having two major surfaces;
transferring the waveguide from the supported state to a suspended state, wherein the waveguide is provided in the suspended state by a contactless suspension system (320, 620) including an ultrasonic vibration generator (512, 514);
gripping the waveguide in the suspended state using a gripper (330, 630); and
transporting the waveguide held by the gripper away from the contactless suspension system.

Embodiment 14. The method of Embodiment 13, further comprising:
positioning the gripper adjacent to the waveguide in the supported state, wherein the transferring of the waveguide from the supported state to the suspended state is performed after the positioning.

Embodiment 15. The method of Embodiment 13 or 14, wherein the transferring of the waveguide from the supported state to the suspended state includes lifting the waveguide from the holder by a contactless suspension force provided by the contactless suspension system, wherein the contactless suspension force moves the waveguide from the holder to a waveguide receiving area of the gripper.

Embodiment 16. The method of any of Embodiments 13 to 15, wherein the contactless suspension system is a first contactless suspension system (320), the method further comprising:
positioning the waveguide held by the gripper adjacent to a second contactless suspension system (620), wherein the second contactless suspension system is equal to or different from the first contactless suspension system;
providing a contactless suspension force by the second contactless suspension system; and
releasing the waveguide from the gripper while the contactless suspension force acts on the waveguide to provide the waveguide in a suspended state using the second contactless suspension system.

Embodiment 17. An apparatus for handling an optical device (10, 10a-c, 202a-b, 310), comprising:
a contactless suspension system (320, 620);
a gripper (330, 630) having a set of side supports (336, 338, 338a-b; 632, 634) that is movable between an open position and a closed position; and
a controller configured to:
   control the contactless suspension system to provide the optical device in a suspended state;
   control the gripper to grip the optical device in the suspended state, wherein the gripping of the optical device includes moving the set of side supports from the open position to the closed position, wherein, in the closed position, one or more side surfaces (316, 318) of the optical device extending between two major surfaces (12, 312, 314) of the optical device are held by the set of side supports; and
   control the gripper to transport the optical device.

While the foregoing is directed to embodiments of the disclosure, other and further embodiments of the disclosure may be devised without departing from the basic scope thereof, and the scope thereof is determined by the claims that follow.

1. A method for handling an optical device, comprising:
providing the optical device in a suspended state using a contactless suspension system, the optical device having two major surfaces;
gripping the optical device in the suspended state using a gripper having a set of side supports, wherein the gripping of the optical device includes moving the set of side supports from an open position to a closed position, wherein, in the closed position, one or more side surfaces of the optical device extending between the two major surfaces of the optical device are held by the set of side supports; and
transporting the optical device using the gripper.

2. The method of claim 1, wherein the optical device is a waveguide comprising a substrate and a plurality of optical structures formed thereon.

3. The method of claim 1, wherein the optical device is transported by the gripper without contacting the two major surfaces of the optical device.

4. The method of claim 1, wherein the set of side supports defines an optical device containment region of the gripper, wherein a dimension of the optical device containment region is adjustable by adjusting a position of at least one side support of the set of side supports.

5. The method of claim 4, wherein moving the set of side supports from the open position to the closed position reduces the dimension of the optical device containment region.

6. The method of claim 4, wherein, in the open position of the set of side supports, a dimension of the optical device containment region is larger than a corresponding dimension of the optical device to allow for a tolerance between the optical device and the set of side supports.

7. The method of claim 1, further comprising:
holding the optical device in a supported state, wherein in the supported state the optical device is mechanically held by a holder;
positioning the gripper adjacent to the optical device in the supported state;
after the positioning, transferring the optical device from the supported state to the suspended state, wherein the transferring includes:
disengaging the optical device from the holder; and
providing the optical device in the suspended state.

8. The method of claim 7, wherein disengaging the optical device from the holder includes lifting the optical device from the holder by a contactless suspension force provided by the contactless suspension system to provide the optical device in the suspended state.

9. The method of claim 7, wherein, upon disengaging the optical device from the holder, a sideward movement of the optical device is restricted by the set of side supports of the gripper.

10. The method of claim 1, wherein the contactless suspension system comprises an ultrasonic vibration generator for providing a contactless repulsive force acting on the optical device.

11. The method of claim 1, wherein the contactless suspension system is a first contactless suspension system, the method further comprising:
positioning the optical device held by the gripper adjacent to a second contactless suspension system, wherein the second contactless suspension system is equal to or different from the first contactless suspension system;
providing a contactless suspension force by the second contactless suspension system; and
releasing the optical device from the gripper while the contactless suspension force acts on the optical device to provide the optical device in a suspended state using the second contactless suspension system.

12. The method of claim 1, wherein the gripper is a second gripper, wherein the method is a method of transferring the optical device from a first gripper to the second gripper via the contactless suspension system, the method further comprising:
holding the optical device using the first gripper;
positioning the optical device held by the first gripper adjacent to the contactless suspension system;
providing a contactless suspension force by the contactless suspension system; and
releasing the optical device from the first gripper while the contactless suspension force acts on the optical device, so that the optical device is provided in a suspended state upon release from the first gripper,
wherein, after the releasing, the optical device in the suspended state is gripped by the second gripper by providing of the set of side supports in the closed position.

13. A method for handling an optical device, comprising:
holding the optical device in a supported state, wherein in the supported state the optical device is mechanically held by a holder, the optical device having two major surfaces;
positioning a gripper adjacent to the optical device in the supported state, the gripper including a set of side supports defining an optical device containment region of the gripper;
after the positioning, transferring the optical device from the supported state to a suspended state, wherein the transferring includes:
disengaging the optical device from the holder; and
providing the optical device in the suspended state using a contactless suspension system;
providing the optical device in the suspended state in the optical device containment region of the gripper while the set of side supports is in an open position;
gripping the optical device in the suspended state by moving the set of side supports from the open position to a closed position to reduce a dimension of the optical device containment region, wherein, in the closed position, one or more side surfaces of the optical device extending between the two major surfaces are held by the set of side supports; and
transporting the optical device away from the contactless suspension system using the gripper.

14. A method for handling a waveguide, comprising:
holding a waveguide in a supported state, wherein in the supported state the waveguide is mechanically held by a holder, the waveguide having two major surfaces;
transferring the waveguide from the supported state to a suspended state, wherein the waveguide is provided in the suspended state by a contactless suspension system including an ultrasonic vibration generator;
gripping the waveguide in the suspended state using a gripper; and
transporting the waveguide held by the gripper away from the contactless suspension system.

15. The method of claim 14, further comprising:
positioning the gripper adjacent to the waveguide in the supported state, wherein the transferring of the waveguide from the supported state to the suspended state is performed after the positioning.

16. The method of claim 14, wherein the transferring of the waveguide from the supported state to the suspended state includes lifting the waveguide from the holder by a contactless suspension force provided by the contactless suspension system, wherein the contactless suspension force moves the waveguide from the holder to a waveguide receiving area of the gripper.

17. The method of claim 14, wherein the contactless suspension system is a first contactless suspension system, the method further comprising:
positioning the waveguide held by the gripper adjacent to a second contactless suspension system, wherein the second contactless suspension system is equal to or different from the first contactless suspension system;
providing a contactless suspension force by the second contactless suspension system; and
releasing the waveguide from the gripper while the contactless suspension force acts on the waveguide to provide the waveguide in a suspended state using the second contactless suspension system.

18. An apparatus for handling an optical device comprising:
a contactless suspension system;
a gripper having a set of side supports that is movable between an open position and a closed position; and
a controller configured to:
control the contactless suspension system to provide the optical device in a suspended state;
control the gripper to grip the optical device in the suspended state, wherein the gripping of the optical device includes moving the set of side supports from the open position to the closed position, wherein, in the closed position, one or more side surfaces of the optical device extending between two major surfaces of the optical device are held by the set of side supports; and
control the gripper to transport the optical device.

19. The apparatus of claim 18, wherein the set of side supports defines an optical device containment region of the gripper, wherein a dimension of the optical device containment region is adjustable by adjusting a position of at least one side support of the set of side supports.

20. The apparatus of claim 19, wherein, in the open position of the set of side supports, a dimension of the optical device containment region is larger than a corresponding dimension of the optical device to allow for a tolerance between the optical device and the set of side supports.
